(19) United States
(12) Patent Application Publication
(10) Pub. No.: US 2026/0210717 A1
(43) Pub. Date: Jul. 23, 2026

(54) THIN-FILM LITHIUM-NIOBATE (TFLN)-BASED MODULATOR FOR FIBER OPTIC GYROSCOPES AND OTHER APPLICATIONS

(71) Applicant: OPTILAB, LLC, Phoenix, AZ (US)

(72) Inventors: Henry H. Hung, Paradise Valley, AZ (US); Ke Huang, Phoenix, AZ (US); Leijun Yin, Tempe, AZ (US); Xiaoyan Ying, Tempe, AZ (US)

(21) Appl. No.: 19/454,004

(22) Filed: Jan. 20, 2026

Related U.S. Application Data
(60) Provisional application No. 63/748,914, filed on Jan. 23, 2025.

(51) Int. Cl. G01C 19/72

(52) U.S. Cl. CPC G01C 19/722; G01C 19/725

(57) ABSTRACT

An aspect of the disclosure relates to an interferometric fiber optic gyroscope (IFOG). The IFOG includes a thin-film lithium niobate (TFLN) substrate including a phase modulator, an optical coupler, and a curved optical waveguide optically coupling the optical coupler to the phase modulator. Another aspect of the disclosure relates to an interferometric fiber optic gyroscope (IFOG). The IFOG includes a thin-film lithium niobate (TFLN) substrate including a phase modulator; and a silicon substrate including a silicon-nitride (SiN) optical coupler and a curved SiN optical waveguide optically coupling the optical coupler to the TFLN phase modulator.

### BACKGROUND

### CROSS-RELATED TO RELATED APPLICATION

This application claims the benefit of the filing date of US Provisional Application, Serial No. 63/748,914, filed on January 23, 2025, which is incorporated herein by reference.

### FIELD

Aspects of the present disclosure relate generally to gyroscopes, current sensing, and other applications, and in particular, to a thin-film lithium-niobate (LiNbO3) (TFLN)-based modulator for fiber optic gyroscope (FOG), current sensing, and other applications.

### Background

Thin-film lithium-niobate (TFLN) modulators are emerging as a groundbreaking solution in the field of photonics, offering compact size, high performance, and seamless integration with photonic platforms. These modulators address critical challenges associated with traditional bulk optical components, including size, cost, and scalability, making them highly attractive for next-generation sensing and navigation technologies.

In fiber optic gyroscopes (FOG), which are widely used for their precision and reliability, traditional designs rely on discrete components such as splitters, couplers, and modulators operating at standard fiber optic communication wavelengths (e.g., 1310 nanometers (nm) or 1550 nm). However, these systems face limitations in terms of miniaturization and integration, hindering their use in compact and portable devices. TFLN-based modulators provide a transformative alternative, enabling more efficient and scalable FOG designs.

Beyond FOGs, TFLN-based modulators are also highly versatile, finding applications in other interferometric sensors, such as current sensors, and paving the way for advanced, high-performance sensing solutions across diverse fields.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

An aspect of the disclosure relates to an interferometric fiber optic gyroscope (IFOG). The IFOG includes a thin-film lithium niobate (TFLN) substrate including a phase modulator, an optical coupler, and a curved optical waveguide optically coupling the optical coupler to the phase modulator.

Another aspect of the disclosure relates to an interferometric fiber optic gyroscope (IFOG). The IFOG includes a thin-film lithium niobate (TFLN) substrate including a phase modulator; and a silicon substrate including a silicon-nitride (SiN) optical coupler and a curved SiN optical waveguide optically coupling the optical coupler to the TFLN phase modulator.

To the accomplishment of the foregoing and related ends, the one or more embodiments include the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the description embodiments are intended to include all such aspects and their equivalents.

### BRIEF DESCRIPTION OF THE DRAWINGS

FIG. 1 illustrates a block diagram of an example interferometric fiber optic gyroscope (IFOG) in accordance with an aspect of the disclosure.

FIG. 2 illustrates a block diagram of an example fiber optic current sensor in accordance with another aspect of the disclosure.

FIG. 3 illustrates a block diagram of an example three-axis interferometric fiber optic gyroscope (IFOG) in accordance with another aspect of the disclosure.

FIGS. 4A-4B illustrate perspective views of example single-axis and three-axis interferometric fiber optic gyroscope (IFOG) in accordance with another aspect of the disclosure.

FIG. 5 illustrates a top view of an example physical implementation of three-axis interferometric fiber optic gyroscope (IFOG) in accordance with another aspect of the disclosure.

FIG. 6 illustrates a top view of another example physical implementation of three-axis interferometric fiber optic gyroscope (IFOG) in accordance with another aspect of the disclosure.

FIGS. 7A-7B illustrate top and side views of another example physical implementation of three-axis interferometric fiber optic gyroscope (IFOG) in accordance with another aspect of the disclosure.

FIGS. 8A-8B illustrate top and views of another example physical implementation of an interferometric fiber optic gyroscope (IFOG) in accordance with another aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Recent advances in photonic integration have paved the way for the development of compact and cost-effective solutions for FOGs. The use of short-wavelength light (e.g., visible to 850nm), compared to traditional communication wavelengths, introduces several advantages. Shorter wavelengths enable the use of lower-cost super-luminescent diodes (SLDs) and photodetectors (PDs), which may be important components in FOG systems. Additionally, the reduced wavelength directly contributes to lower half-wave voltages (Vpi), allowing the design of smaller and more efficient phase modulators. These advantages are particularly beneficial for modern navigation systems requiring high performance within constrained size and power budget.

Lithium niobate (LiNbO₃) has long been a material of choice for optical modulators due to its excellent electro-optic properties. The advent of thin-film LiNbO₃ (TFLN) technology has further enhanced the potential for integration, enabling the fabrication of compact, high-performance modulators. Moreover, hybrid integration of thin-film LiNbO₃ (TFLN) with silicon photonics platforms combines the desirable features of both technologies: the high electro-optic efficiency of LiNbO₃ and the dense integration capability of silicon photonics. This hybrid approach facilitates the fabrication of complex photonic circuits, including couplers, modulators, and other components, on a single chip.

The development of compact lithium niobate (LiNbO₃)-based modulator platforms for short-wavelength applications addresses key challenges in fiber optic gyroscopes (FOGs) and unlocks new possibilities for their design. This patent provides solutions across three distinct platforms: bulk, thin-film, and hybrid thin-film lithium niobate photonics, each offering different levels of compactness and integration. By leveraging these approaches, it becomes feasible to design and fabricate multi-axis FOG systems with varying degrees of miniaturization and performance optimization. Integration of components such as couplers and phase modulators on a single platform reduces system size, cost, and complexity while enhancing performance and manufacturability. Furthermore, the capability to implement three-axis operation on a single chip represents a significant advancement in photonic integration for FOGs, enabling more versatile and efficient system designs tailored to diverse application needs.

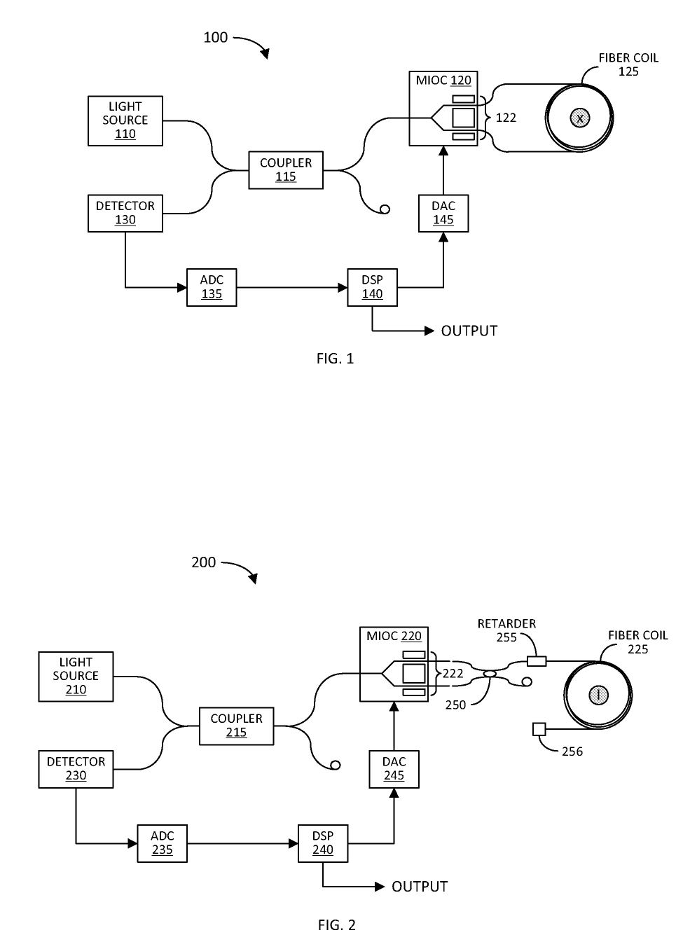

FIG. 1 illustrates a block diagram of an example interferometric fiber optic gyroscope (IFOG) 100 in accordance with an aspect of the disclosure. The IFOG 100 includes a light or optical signal source (e.g., a Super-Luminescent Diode (SLD)) 110, an optical coupler 115, a multi-functional integrated optical chip (MIOC) 120 including a Lithium Niobate phase modulator 122, and a fiber coil 125. The IFOG 100 further includes a detector 130, an analog-to-digital converter (ADC) 135, a digital signal processor (DSP) 140, and a digital-to analog converter (DAC) 145.

The light source 110 is configured to generate an optical signal (e.g., an SLD). In the forward direction, the optical coupler 115 is configured to direct the optical signal to an input of the Lithium Niobate phase modulator 122. The Lithium Niobate phase modulator 122 is configured to phase modulated the optical signal based on an analog bias modulation signal generated by the DAC 145 to generate a phase-modulated clockwise (CW) optical signal and a phase-modulated counterclockwise (CCW) optical signal. The phase-modulated CW optical signal and the phase-modulated CCW optical signal enter the fiber coil 125 from the top port and bottom port, respectively. The phase-modulated CW optical signal propagates through the fiber coil 125 in a CW direction and exits out the bottom port of the fiber coil 125. The phase-modulated CCW optical signal propagates through the fiber coil 125 in a CCW direction and exits out the top port of the fiber coil 125.

Rotation of the fiber coil 125 about a central axis (X-axis, oriented into/out of the page) modulates the phases of the phase-modulated CW and CCW signals. The phase-modulated CW and CCW signals interfere (constructively or destructively) at the Lithium Niobate phase modulator 122 of the MIOC phase modulator 120, producing a combined optical signal whose amplitude is directly related to the central axis rotation of the fiber coil 125, making it suitable for gyroscopic applications. The optical coupler 115 then routes the combined optical signal to the detector 130, which generates an analog electrical signal proportional to the optical signal. This analog signal is converted into a digital format by the ADC 135 and processed by the DSP 140.

The DSP 140 computes the gyroscope output, corresponding to the central axis rotation of the fiber coil 125. Additionally, the DSP 140 generates a digital bias modulation signal, which the DAC 145 converts into the analog bias modulation signal for system operation.

FIG. 2 illustrates a block diagram of an example fiber optic current sensor 200 in accordance with another aspect of the disclosure. The fiber optic current sensor 200 shares similarities with the previously discussed IFOG 200, including many of the same elements. These shared elements are denoted by the same reference numbers, with the most significant digit updated to “2” for the fiber optic current sensor 200 instead of “1” for the IFOG 100.

The fiber optic current sensor 200 differs from IFOG 100 in several respects. First, the fiber optic current sensor 200 senses current I flowing through an electrical conductor (e.g., high voltage wire or cable) extending coaxially through the fiber coil 225. Second, the fiber coil 225 is single-port rather than dual port, and terminates in a mirror 256. The fiber optic current sensor 200 further includes a second coupler 250 and a retarder 255. The second coupler 250 combines the phase modulated optical signal generated by the MIOC phase modulator 220, and the retarder 255 converts the polarization of the combined optical signal between linear and circular.

The circularly polarized optical signal propagates in the CW direction along the fiber coil 225 and reflects off the terminated mirror. The reflected polarized optical signal propagates along the fiber coil 225 in the CCW direction. The current I through the electrical conductor modulates the phases of the CW and CCW propagating polarized optical signals. The phase-modulated polarized optical signal exits the fiber coil 225 gets linearly polarized by the retarder 255. The second coupler 250 separates the current-phase-modulated optical signals into two current-phase-modulated optical signals. The two current-phase-modulated optical signals constructively or destructively combine at the MIOC phase modulator 220 to generate a combined optical signal. The amplitude of the combined optical signal is related to the current I flowing through the electrical conductor.

The first optical coupler 215 routes the combined optical signal to the detector 230. The detector 230 generates an analog electrical signal based on the combined optical signal. The ADC 235 converts the analog electrical signal into a digital signal. The DSP 240 processes the digital signal to generate the current information of the current flowing through the electrical conductor. The remaining components operates similar to the corresponding components of IFOG 100 previously discussed in detail.

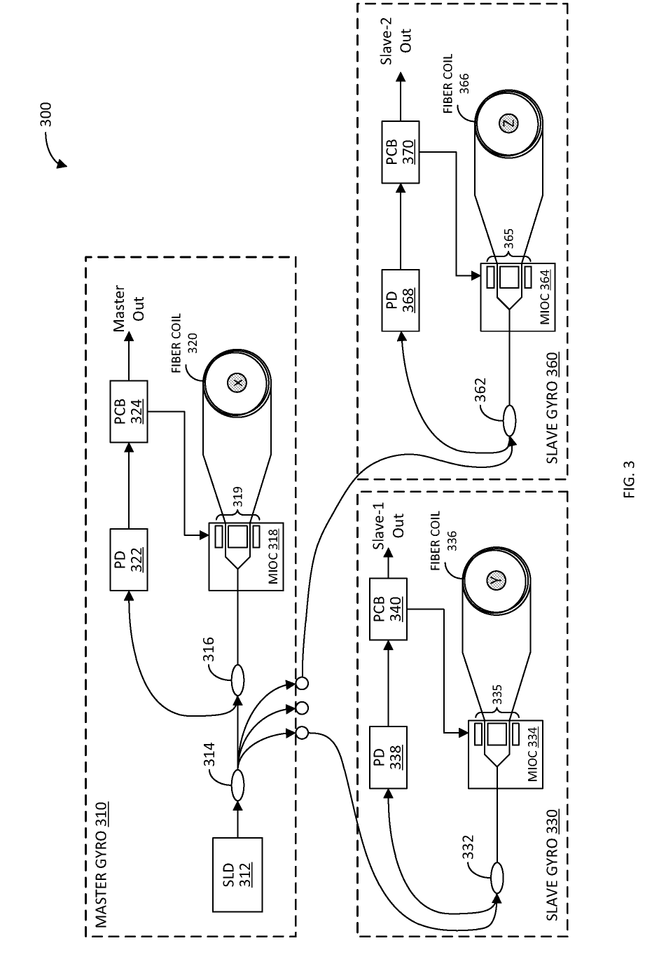

FIG. 3 illustrates a block diagram of an example three-axis interferometric fiber optic gyroscope (IFOG) 300 in accordance with another aspect of the disclosure. The IFOG 300 includes a master gyro sensor 310, a first slave gyro sensor 330, and a second slave gyro sensor 360. As an example, the master gyro sensor 310 may be configured to sense the rotation of the fiber coil 320 about an x-cartesian axis. The first slave gyro sensor 330 may be configured to sense the rotation of the fiber coil 336 about a y-cartesian axis. And, the second slave gyro sensor 360 may be configured to sense the rotation of the fiber coil 366 about a z-cartesian axis.

The master gyro sensor 310 includes an SLD 312, a 1x4 coupler 314, 1x2 coupler 316, a Lithium Niobate phase modulator 319 implemented in an MIOC 318, a fiber coil 320, a PD 322, and a printed circuit board (PCB) circuit 324. The first slave gryo sensor 330 includes a 1x2 coupler 332, a Lithium Niobate phase modulator 335 implemented in an MIOC 334, a fiber coil 336, a PD 338, and a PCB circuit 340. The second slave gryo sensor 360 includes a 1x2 coupler 362, a Lithium Niobate phase modulator 365 implemented in an MIOC 364, a fiber coil 366, a PD 368, and a PCB circuit 370.

The SLD 312 is configured to generate a broadband optical signal. The 1x4 coupler 314 is configured to split the optical signal into four (4) optical signals: one for the master gyro sensor 310, one for the first slave gyro sensor 330, one for the second slave gyro sensor 360, and one to serve as a spare or for optical power monitoring purpose. In the forward direction, the 1x2 coupler 316 is configured to direct the master optical signal to the Lithium Niobate phase modulator 319. The Lithium Niobate phase modulator 319 is configured to phase modulate the master optical signal based on a phase modulation signal generated by the PCB circuit 324 to generate phase-modulated CW and CCW optical signals.

The phase-modulated CW optical signal propagates through the fiber coil 320 from its top port to its bottom port in a CW direction. The phase-modulated CCW optical signal propagates through the fiber coil 320 from its bottom port to its top port in a CCW direction. The rotation of the fiber coil 320 about the x-axis modulates the phases of the phase-modulated CW and CCW optical signals. The phase-modulated CW and CCW optical signals exit the fiber coil 320 and constructively or destructively combine at the Lithium Niobate phase modulator 319 based on their respective phases. Accordingly, the amplitude of the combined optical signal is related to the rotation of the fiber coil 320 about the x-axis. In the reverse direction, the 1x2 coupler 316 directs the combined optical signal to the PD 322 for conversion into an electrical signal. The PCB 324 processes the electrical signal to generate the x-rotation gyro information.

With regard to the first slave gyro sensor 330, in the forward direction, the 1x2 coupler 332 is configured to direct the first slave optical signal to the Lithium Niobate phase modulator 335. The Lithium Niobate phase modulator 335 is configured to phase modulate the first slave optical signal based on a phase modulation signal generated by the PCB circuit 340 to generate phase-modulated CW and CCW optical signals. The phase-modulated CW optical signal propagates through the fiber coil 336 from its top port to its bottom port in a CW direction. The phase-modulated CCW optical signal propagates through the fiber coil 336 from its bottom port to its top port in a CCW direction. The rotation of the fiber coil 336 about the y-axis modulates the phases of the phase-modulated CW and CCW optical signals. The phase-modulated CW and CCW optical signals exit the fiber coil 336 and constructively or destructively combine at the Lithium Niobate phase modulator 335 based on their respective phases. Accordingly, the amplitude of the combined optical signal is related to the rotation of the fiber coil 336 about the y-axis. In the reverse direction, the 1x2 coupler 332 directs the combined optical signal to the PD 338 for conversion into an electrical signal. The PCB 340 processes the electrical signal to generate the y-rotation gyro information.

With regard to the second slave gyro sensor 360, in the forward direction, the 1x2 coupler 362 is configured to direct the second slave optical signal to the Lithium Niobate phase modulator 365. The Lithium Niobate phase modulator 365 is configured to phase modulate the second slave optical signal based on a phase modulation signal generated by the PCB circuit 370 to generate phase-modulated CW and CCW optical signals. The phase-modulated CW optical signal propagates through the fiber coil 366 from its top port to its bottom port in a CW direction. The phase-modulated CCW optical signal propagates through the fiber coil 366 from its bottom port to its top port in a CCW direction. The rotation of the fiber coil 366 about the z-axis modulates the phases of the phase-modulated CW and CCW optical signals. The phase-modulated CW and CCW optical signals exit the fiber coil 366 and constructively or destructively combine at the Lithium Niobate phase modulator 365 based on their respective phases. Accordingly, the amplitude of the combined optical signal is related to the rotation of the fiber coil 366 about the z-axis. In the reverse direction, the 1x2 coupler 362 directs the combined optical signal to the PD 368 for conversion into an electrical signal. The PCB 370 processes the electrical signal to generate the z-rotation gyro information.

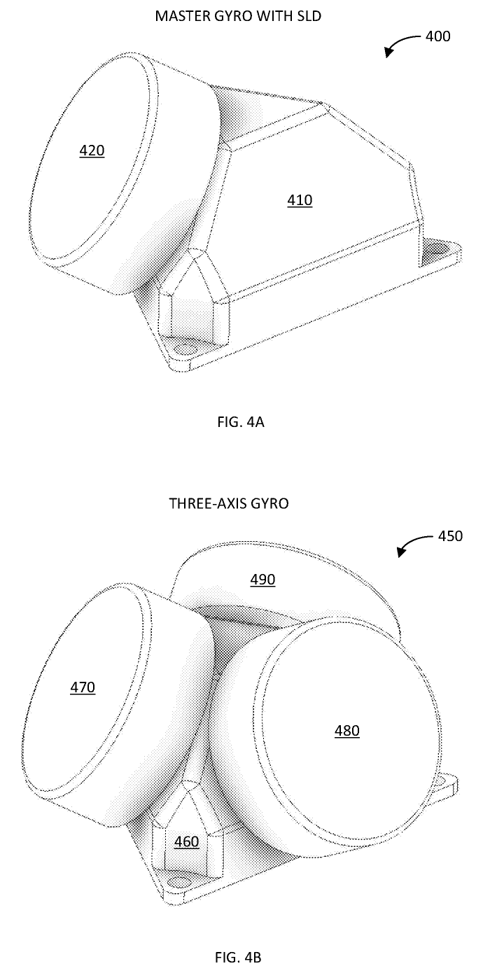

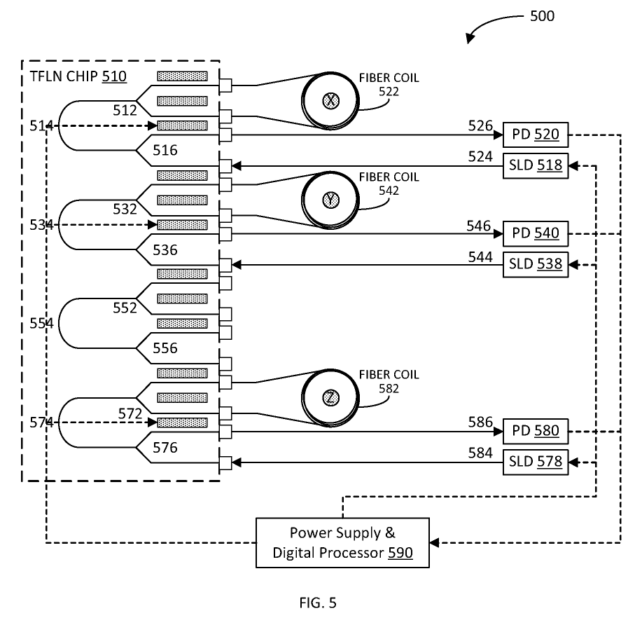

FIGS. 4A illustrates a perspective view of example master interferometric fiber optic gyroscopes (IFOG) 400 in accordance with another aspect of the disclosure. This disclosure presents a novel packaging method for interferometric fiber optic gyroscopes (IFOGs) that enables flexible integration of multi-axis systems. The design features a master IFOG package 400 for a single axis, which can operate independently, and two optional pluggable slave packages in FIG. 4B for additional axes. This modular approach allows for seamless scaling from a single-axis to multi-axis configurations, enhancing system versatility while maintaining compactness and simplifying assembly, maintenance, and customization for diverse application needs. The master IFOG 400 includes a main hub 410 for housing the SLD 312, 1x2 coupler 316, phase modulator 319, PD 322, and PCB 324. The master IFOG 400 includes a sensor hub 420 for housing the fiber coil 320.

FIGS. 4B illustrates a perspective view of example three-axis interferometric fiber optic gyroscopes (IFOG) 450 in accordance with another aspect of the disclosure. The three-axis IFOG 450 includes a main hub 460 for housing the SLD 312, 1x4 coupler 314, 1x2 couplers 316, 332, and 364, phase modulators 319, 335, and 365, PDs 322, 338, and 368, and PCBs 324, 340, and 370. The three-axis IFOG 450 includes an x-axis sensor hub 470 for housing the x-axis sensor fiber coil 320, a y-axis sensor hub 480 for housing the y-axis sensor fiber coil 336, and z-axis sensor hub 490 for housing the z-axis sensor fiber coil 366.

FIG. 5 illustrates a top view of an example physical implementation of three-axis interferometric fiber optic gyroscope (IFOG) 500 in accordance with another aspect of the disclosure. The IFOG 500 includes a TFLN chip or substrate 510 including a set of TFLN phase modulators 512, 532, 552, and 572, a set of 180-degree TFLN waveguides 514, 534, 554, and 574, and a set of optical couplers 516, 536, 556, and 576. The IFOG 500 further includes a set of fiber coils 522, 542, and 582. The IFOG 500 further includes a set of SLDs 518, 538, and 578, a set of PDs 520, 540, and 580, a first set of optical fibers 524, 544, and 584, and a second set of optical fibers 526, 546, and 586. Further, the IFOG 500 includes a power supply and digital processor 590.

With regard to x-rotation gyro sensing, the SLD 518 is coupled to the optical coupler 516 via the optical fiber 524. The optical coupler 516 is coupled to the PD 520 via the optical fiber 526. The optical coupler 516 is optically coupled to the Y-splitter/combiner of the TFLN phase modulator 512 via the 180-degree curved TFLN waveguide 514. The power supply and digital processor 590 is coupled to the electrodes (e.g., shown as shaded rectangles) of the TFLN phase modulator 512. The TFLN phase modulator 512 is optically coupled to the fiber coil 522.

With regard to y-rotation gyro sensing, the SLD 538 is coupled to the optical coupler 536 via the optical fiber 544. The optical coupler 536 is coupled to the PD 540 via the optical fiber 546. The optical coupler 536 is coupled to the Y-splitter/combiner of the TFLN phase modulator 532 via the 180-degree curved TFLN waveguide 534. The power supply and digital processor 590 is coupled to the electrodes (e.g., shown as shaded rectangles) of the TFLN phase modulator 532. The TFLN phase modulator 532 is optically coupled to the fiber coil 542.

With regard to z-rotation gyro sensing, the SLD 578 is coupled to the optical coupler 576 via the optical fiber 584. The optical coupler 576 is coupled to the PD 580 via the optical fiber 586. The optical coupler 576 is coupled to the Y-splitter/combiner of the TFLN phase modulator 572 via the 180-degree curved TFLN waveguide 574. The power supply and digital processor 590 is coupled to the electrodes (e.g., shown as shaded rectangles) of the TFLN phase modulator 572. The TFLN phase modulator 572 is optically coupled to the fiber coil 582.

The coupler 556, 180-degree bent TFLN waveguide 554, and TFLN phase modulator 552 pertain to a spare sensor in case any one of the x-, y-, and z-components fail for any reason. The power supply and digital processor 590 is electrically coupled to the set of SLDs 518, 538, and 578 as shown per the dashed lines. The power supply and digital processor 590 is also electrically coupled to the set of PDs 520, 540, and 580 as shown per the dashed lines.

In operation, the set of SLDs 524, 544, and 584 generate a set of optical signals (e.g., CW wave). The set of optical signals propagate to the set of couplers 516, 536, and 576 via the set of optical fibers 524, 544, and 584, respectively. In the forward direction, the set of couplers 516, 536, and 576 direct the set of optical signals to the set of TFLN phase modulators 512, 532, and 572 via the set of 180-degree curved TFLN waveguides 514, 534, and 574, respectively. The set of TFLN phase modulators 512, 532, and 572 modulate the set of optical signals based on a bias modulation signal generated by the power supply and digital processor 590 to generate a set of phase-modulated CW optical signals and a set of phase-modulated CCW optical signals. The 180-degree input/output waveguide (WG) bending can also be 90-degree based on different configurations, which significantly reduces residual stray light coupling to the PDs and is crucial for the stability and sensitivity of FOGs. Such leakage light can lead to phase noise or unintended interference, which negatively impacts the precision of FOGs. One special design incorporated in the chip is the four MIOCs on one three-axis chip, later three ones out of four can be picked for fiber pig tailing, improving the yield.

As previously discussed, the set of phase-modulated CW optical signals propagate through the set of fiber coils 522, 542, and 582 in the CW direction from the top ports to the bottom ports of the set of fiber coils 522, 542, and 582, respectively. The set of phase-modulated CCW optical signals propagate through the set of fiber coils 522, 542, and 582 in the CCW direction from the bottom ports to the top ports of the set of fiber coils 522, 542, and 582, respectively. The rotations about the x-, y-, and z-axes by the set of fiber coils 522, 542, and 582 modulate the phases of the sets of phase-modulated CW and CCW optical signals, respectively.

The phase-modulated sets of CW and CCW optical signals constructively or destructively combine at the set of TFLN phase-modulated optical signals 512, 532, and 572 based on the phases of the sets of CW and CCW optical signals modulated by the set of fiber coils 522, 542, and 582, respectively. The set of combined optical signals propagate to the set of couplers 516, 536, and 576 via the set of 180-degree curved TFLN waveguides 514, 534, and 574, respectively. In the reverse direction, the set of optical couplers 516, 536, and 576 direct the set of combined optical signals to the set of PDs 520, 540, and 580 via the set of optical fibers 526, 546, and 586, respectively. The set of PDs 520, 540, and 580 convert the set of combined optical signals to a set of electrical signals, respectively. The power supply and digital processor 590 processes the set of electrical signals to generate the x-, y-, and z-axes gyro rotation information of the set of fiber coils 522, 542, and 582, respectively.

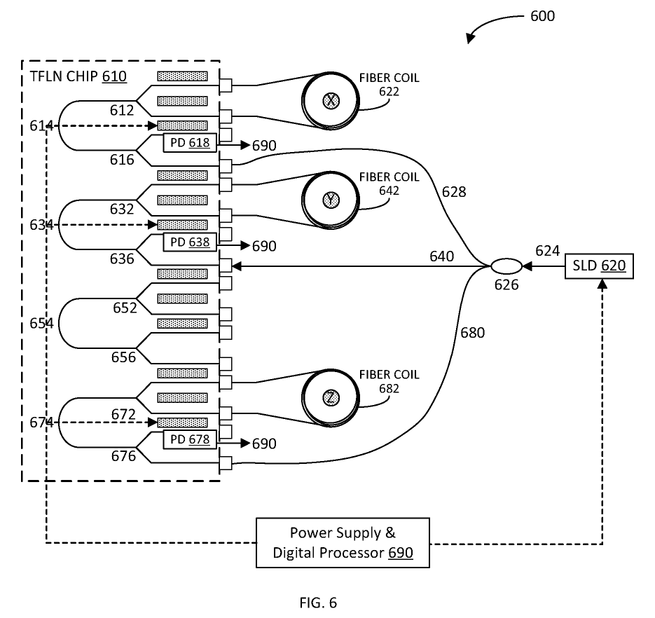

FIG. 6 illustrates a top view of another example physical implementation of three-axis interferometric fiber optic gyroscope (IFOG) 600 in accordance with another aspect of the disclosure. The IFOG 600 is a variation of IFOG 500 previously discussed and includes similar elements as indicated by the same reference numbers with the exception that their most significant digit is an “6” for IFOG 800 instead of a “5” as in IFOG 500, and operate in a similar manner as previously discussed in detail.

The IFOG 600 differs from IFOG 500 in several manners: (1) there is a single SLD 620 in IFOG 600 instead of three (3) SLDs 518, 538, and 578 as in IFOG 500; (2) the set of PDs 618, 638, and 678 in IFOG 600 are integrated on the TFLN chip or substrate 610; (3) a 1x3 coupler 626 is provided in IFOG 600 is configured to receive an optical signal (e.g., CW wave) from the SLD 620 via optical fiber 624 and split the optical signal into a set of three (3) optical signals. The set of three (3) optical signals are provided to the set of optical couplers 616, 636, and 676 via a set of optical fibers 628,640, and 680, respectively. Although not explicitly shown, the set of PDs 618, 638, and 678 are electrically coupled to provide the set of electrical signals to the power supply and digital processor 690. The power supply and digital processor 690 processes the set of electrical signals to generate the x-, y-, and z-axes gyro rotation information of the set of fiber coils 622, 642, and 682, respectively.

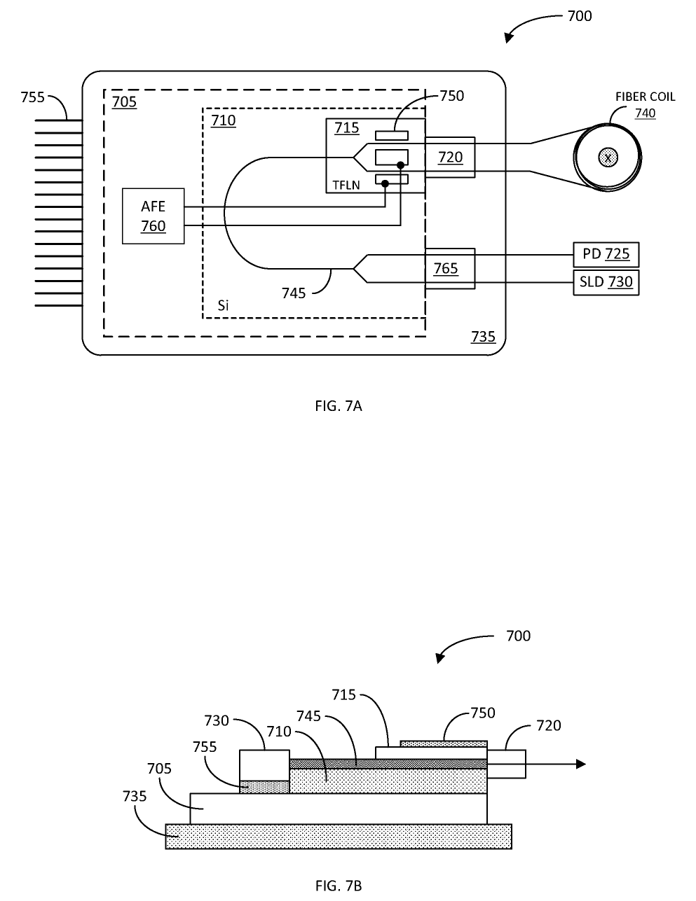

FIGS. 7A-7B illustrate top and side cross-sectional views of another example physical implementation of an interferometric fiber optic gyroscope (IFOG) 700 in accordance with another aspect of the disclosure. The IFOG 700 includes a substrate 705 (e.g., PCB, glass core substrate, or other). The IFOG 700 includes a silicon substrate 710 disposed over or mounted on the substrate 705. Additionally, the IFOG 700 includes TFLN substrate 715 associated with a TFLN phase modulator (also referred to as 715) disposed over or mounted on the silicon (Si) substrate 710. Note that the single-axis IFOG 700 has the option to be integrated into a three-axis configuration on a single chip, similar to the IFOG 500 and 600.

The IFOG 700 also includes a package 735 upon which the substrate 705 and fiber blocks 720 and 765 are disposed or mounted. The IFOG 700 further includes an analogue front end (AFE) 760 disposed or mounted on the substrate 705 and electrically coupled to electrodes 750 associated with the TFLN phase modulator 715. The IFOG 700 includes a set of pins 755 coupled to the package 735 to provide electrical signals to and/or from the AFE 760.

The IFOG 700 includes a fiber coil 740 optically coupled to the TFLN phase modulator 715 via optical block 720. Also, the IFOG 700 includes a PD 725 and SLD 730 optically coupled to an optical waveguide (e.g., silicon nitride (SiN)) 745 implemented in the silicon substrate 710 via the fiber block 765. The optical waveguide 745 includes an optical coupler and a 180-degree bended waveguide as previously discussed. Although not shown, the PD 725 and SLD 730 may be electrically coupled to the AFE 760. The IFOG 700 operates in a same/similar manner as the IFOGs previously discussed in detail.

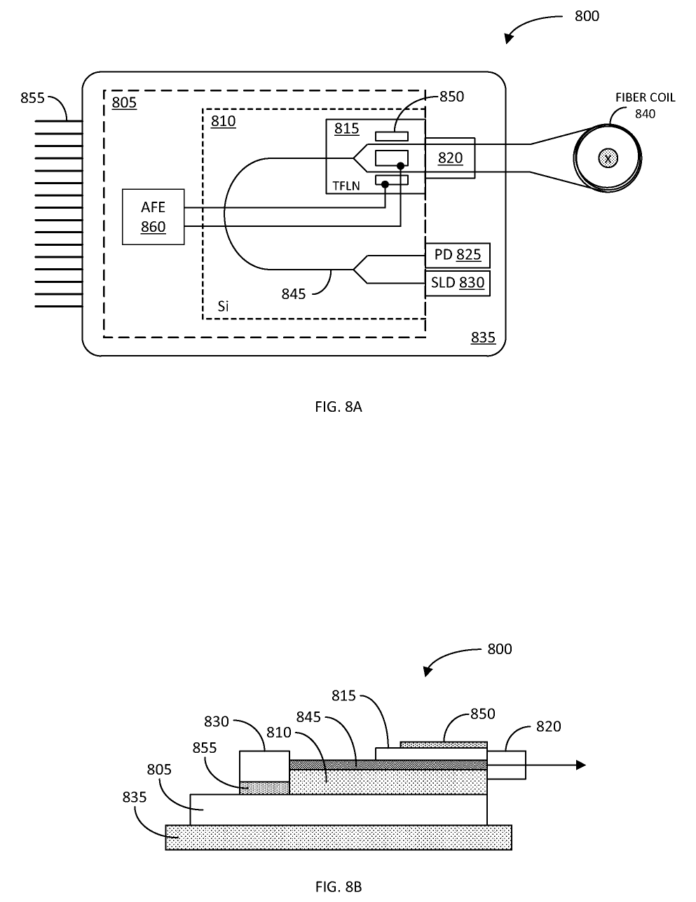

FIG. 8 illustrates top and side cross-sectional views of another example physical implementation of three-axis interferometric fiber optic gyroscope (IFOG) 800 in accordance with another aspect of the disclosure. The IFOG 800 is similar to IFOG 700 including many of the same/similar elements as indicated by the same reference numbers with the exception that their most significant digit is a “8” for IFOG 800 instead of a “7” as in IFOG 700.

The IFOG 800 differs from IFOG 700 in several manners: (1) the PD 825 and the SLD 830 are disposed or mounted on the package 835; (2) the PD 825 and SLD 830 are optically edge coupled to the SiN waveguide 845, or may be bonded on the silicon substrate 810; and (3) the PD 825 and SLD 830 are electrically coupled to the AFE 860 via electrical conductors implemented on the silicon substrate 810 and/or substrate 805.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. An interferometric fiber optic gyroscope (IFOG), comprising: a thin-film lithium niobate (TFLN) substrate including a phase modulator, an optical coupler, and a curved optical waveguide optically coupling the optical coupler to the phase modulator.

2. The IFOG of claim 1, wherein the curved optical waveguide includes a substantially 180-degree bended optical waveguide.

3. The IFOG of claim 1, wherein the curved optical waveguide includes a substantially 90-degree bended optical waveguide.

4. The IFOG of claim 1, further comprising a fiber coil optically coupled to the phase modulator.

5. The IFOG of claim 1, further comprising an optical signal source optically coupled to the optical coupler.

6. The IFOG of claim 5, wherein the optical signal source comprises a super-luminescent diode (SLD).

7. The IFOG of claim 5, wherein the optical signal source is optically edged coupled to the optical coupler.

8. The IFOG of claim 1, further comprising a photodetector optically coupled to the optical coupler.

9. The IFOG of claim 8, wherein the photodetector is optically coupled to the optical coupler via an optical fiber.

10. The IFOG of claim 8, wherein the photodetector is optically edged coupled to the optical coupler.

11. An interferometric fiber optic gyroscope (IFOG), comprising:
a thin-film lithium niobate (TFLN) substrate including a phase modulator; and
a silicon substrate including a silicon-nitride (SiN) optical coupler and a curved SiN optical waveguide optically coupling the optical coupler to the TFLN phase modulator.

12. The IFOG of claim 11, wherein the curved SiN optical waveguide includes a substantially 180-degree bended optical waveguide.

13. The IFOG of claim 11, wherein the SiN curved optical waveguide includes a substantially 90-degree bended optical waveguide.

14. The IFOG of claim 11, further comprising a fiber coil optically coupled to the phase modulator.

15. The IFOG of claim 11, further comprising an optical signal source optically coupled to the optical coupler.

16. The IFOG of claim 15, wherein the optical signal source comprises a super-luminescent diode (SLD).

17. The IFOG of claim 15, wherein the optical signal source is optically edged coupled to the optical coupler.

18. The IFOG of claim 11, further comprising a photodetector optically coupled to the optical coupler.

19. The IFOG of claim 18, wherein the photodetector is optically coupled to the optical coupler via an optical fiber.

20. The IFOG of claim 18, wherein the photodetector is optically edged coupled to the optical coupler.

21. The IFOG of claim 11, wherein the TFLN phase modulator is mounted on the silicon substrate.
